(19) United States
(12) Patent Application Publication
(10) Pub. No.: US 2015/0215117 A1
(43) Pub. Date: Jul. 30, 2015

(54) WHITE BOX ENCRYPTION APPARATUS AND METHOD

(71) Applicant: ELECTRONICS AND TELECOMMUNICATIONS RESEARCH INSTITUTE, Daejeon (KR)

(72) Inventors: Ju Han KIM, Daejeon (KR); Seung Kwang LEE, Daejeon (KR); Doo Ho CHOI, Cheonan-si, Chungcheongnam-do (KR)

(73) Assignee: ELECTRONICS AND TELECOMMUNICATIONS RESEARCH INSITUTE, Daejeon (KR)

(21) Appl. No.: 14/608,878

(22) Filed: Jan. 29, 2015

(30) Foreign Application Priority Data
Jan. 29, 2014 (KR) 10-2014-0011088

(51) Int. Cl. H04L 9/08

(52) U.S. Cl. CPC H04L 9/0816; H04L 2209/24

(57) ABSTRACT

Disclosed are a white box encryption apparatus and method. The white box encryption method includes performing an encryption operation using a plurality of white box encryption tables for each of a plurality of rounds, and mixing arrangement of result tables output for each round.

### CROSS-REFERENCE TO RELATED APPLICATION

This application claims priority to and the benefit of Korean Patent Application No. 10-2014-0011088, filed on Jan. 29, 2014, the disclosure of which is incorporated herein by reference in its entirety.

### BACKGROUND

1. Field of the Invention

The present invention relates to encryption technology in which white box encryption is more reliably measured.

2. Discussion of Related Art

As encryption technologies, white box encryption technology and black box encryption technology are used. A black box encryption algorithm is the conventional technology, and the white box technology is the latest and more reliable technology.

The encryption technology simply refers to technology that changes a plain text into a ciphertext. That is, the encryption technology encrypts the plain text so that a cracker is disabled from knowing the encrypted plain text. Such encryption technology may be a software code or a hardware device. The encryption technology is based on a black box or a white box regardless of the type of the encryption technology.

The encryption technology based on the black box requires an encryption key in a process of encrypting plain texts. The encryption key is included inside an encryption apparatus assumed to be the black box. The black box means that the inside of the black box cannot be seen. That is, the design of the encryption apparatus based on the black box starts from the assumption that a cracker cannot look inside the encryption apparatus. Thus, the cracker can see only a plain text input to the encryption apparatus based on the black box and an encrypted text output from the same. The cracker possibly continues to observe two input/output values to figure out any pattern. In the black box, the designer of the encryption apparatus simply assumes that the encryption apparatus itself is perfectly safe. That is, the designer of the encryption apparatus assumes the encryption apparatus to be the black box. Thus, if the encryption apparatus itself is tempered with, the encryption key may be leaked. When the encryption key is leaked, all the encryption process is completely exposed to the cracker.

The white box encryption technology is a more advanced method than the encryption technology based on the black box. The white box may be interpreted as a white box, but can be differently interpreted as a transparent box. The white box encryption technology starts from the assumption that a cracker can eventually look inside the encryption apparatus using any method. If the cracker can eventually look inside the encryption apparatus, the cracker can acquire the encryption key, and therefore the designer of the encryption apparatus should consider more details. When it is assumed that the encryption apparatus is the white box, the encryption key cannot be easily stored in the encryption apparatus. Thus, in a general white box, the encryption key is obfuscated with a complex encryption operation algorithm while it does not exist as is. As a result, the encryption key cannot be obtained separately. In addition, the complex encryption operation algorithm is an algorithm that is difficult to be inverted. Thus, it is difficult to guess the original value or the encryption key using a result value.

The black box based-encryption technology may be represented as Equation of Y=algorithm1 (x, key1), and the encryption process in the white box may be represented as Equation of Y=algorithm2 (x). That is, if the encryption key that is input information is safely hidden in the form that cannot be easily leaked from the inside of the encryption algorithm, it is difficult for a hacker to infer the encryption key even if the hacker monitors an encryption operation algorithm driven based on the white box.

In this manner, since a current white box cryptography does not use the encryption key, the encryption key is not leaked and is compatible with the standard encryption technology. However, when the white box encryption algorithm itself in which the encryption key is hidden is leaked, a corresponding ciphertext may be decrypted through the leaked white box encryption algorithm, and therefore the white box encryption algorithm is difficult to be used in security-vulnerable areas.

### SUMMARY OF THE INVENTION

The present invention is directed to a white box encryption apparatus and method that may maintain security and safety even in a state in which a white box encryption algorithm itself with an encryption key hidden therein is leaked.

According to an aspect of the present invention, there is provided a white box encryption apparatus including: an operation unit that performs an encryption operation using a plurality of white box encryption tables for each of a plurality of rounds; and a table mixing unit that mixes arrangement of result tables output for each round.

According to another aspect of the present invention, there is provided a white box encryption method including: performing an encryption operation using a plurality of white box encryption tables for each of a plurality of rounds; and mixing arrangement of result tables output for each round.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a basic principle of a white box cryptography according to an exemplary embodiment of the present invention;

FIG. 2 is a diagram illustrating operation sequences of a white box AES according to an exemplary embodiment of the present invention;

FIG. 3 is a diagram illustrating a structure of a Type 2 table among tables shown in FIG. 2;

FIG. 4 is a diagram illustrating a structure of a Type 1B table among tables shown in FIG. 2;

FIG. 5 is a diagram illustrating a structure of a Type 1B table among tables shown in FIG. 2;

FIG. 6 is a block diagram illustrating a configuration of a white box encryption apparatus according to an exemplary embodiment of the present invention;

FIGS. 7A and 7B are a diagram illustrating a process of decrypting a dynamically changed white box cryptography according to an exemplary embodiment of the present invention; and

FIG. 8 is a schematic block diagram illustrating a computer system to which a white box encryption apparatus according to an exemplary embodiment of the present invention can be applied.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

In the present invention, there is provided a method that should have inverse operation information related to operation information operated between each round even in a case in which a code (or table) or the like implemented by a white box encryption algorithm is leaked, whereby normal encryption and decryption are possible.

Hereinafter, an embodiment of the present invention will be described in detail with reference to the accompanying drawings.

Basic Principle of White Box Encryption Applied to the Present Invention

FIG. 1 is a diagram illustrating a basic principle of a white box cryptography according to an exemplary embodiment of the present invention.

The basic principle of a white box cryptography is as shown in FIG. 1. The traditional encryption mechanism is operated on the assumption that an encryption key is safely maintained and managed in a black box device (reliable terminal). On the other hand, in a white box encryption mechanism, since an encryption key is obfuscated in an encryption algorithm implemented by software, the white box encryption mechanism is operated on the assumption that a cracker cannot easily see the encryption key. That is, the white box encryption is a technique in which an encryption algorithm is made as a large lookup table and the encryption key is hidden inside the lookup table in a state of being obfuscated with the encryption algorithm implemented by software so that the encryption key is prevented from being easily inferred even if the internal operation is analyzed. When the encryption algorithm is made as a single large lookup table, it is easy to hide the encryption key, but the size of the table which becomes excessively large is unrealistic, and therefore decoding and encoding processes should be performed so as to prevent exposure of an intermediate value of an encryption operation while the table is appropriately separated in a cryptographic technique.

As shown in FIG. 1, in the basic principle of the basic white box encryption, an encoding process Mᵢ and a decoding process Mi⁻¹ are calculated in separate tables, and therefore the basic principle of the basic white box encryption may be the same as the result obtained in such a manner that encoding and decoding are eventually offset to perform only an original encryption operation Xᵢ while the intermediate value is not exposed.

White Box Advanced Encryption Standard (WB-AES) Operation Mechanism Applied to the Present Invention

The WB-AES applied to the present invention performs a round operation including repeatedly performing ShiftRows that shifts rows, AddRoundKey that adds a round key, SubBytes that substitutes for a key, and MixColumns that mixes columns. That is, in the WB-AES applied to the present invention, AddRoundKey for initial key whitening is performed in a first round and AddRoundKey of the first round is performed in the next round operation, and therefore each round starts with AddRoundKey and ends with MixColumns. The reason why the round operation should end with MixColumns in the WB-AES is related to a process in which the WB-AES is made as a plurality of small lookup tables rather than a single large lookup table when the WB-AES is implemented. The operation results are the same although the order of the ShiftRows operation is changed with the orders of AddRoundKey and Sub-Bytes, and therefore ShiftRows is performed at the beginning of every round operation for the convenience of implementation.

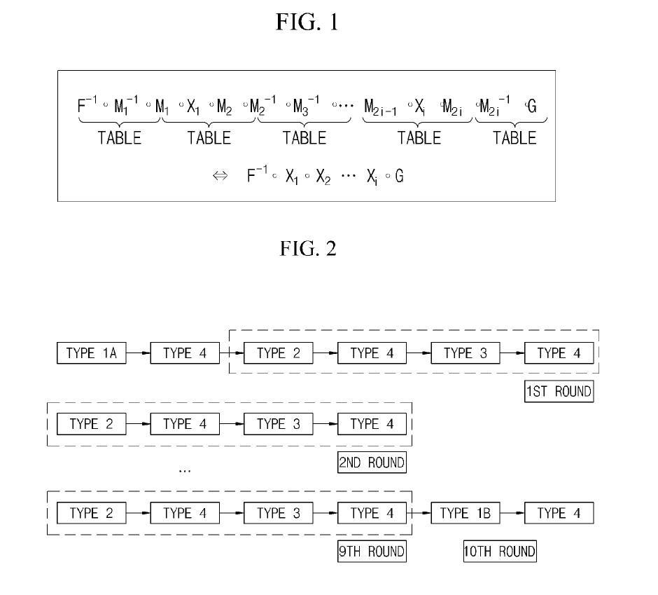

FIG. 2 is a diagram illustrating operation sequences of a white box AES according to an exemplary embodiment of the present invention.

The WB-AES applied to the present invention is constituted of 5 tables such as Type 1A, Type 1B, Type 2, Type 3, and Type 4, and input data and output data of each table are configured in order to prevent the internal operation of the table from being easily exposed through nonlinear conversion in which two nibble inputs (4-bit input) is permutated to perform decoding and encoding.

As shown in FIG. 2, the operation sequences of AES using 5 tables may be constituted of 11 rounds including an initial round, . . . . , a ninth round, and a final round. In particular, in the operation sequences shown in FIG. 2, Type 4 table operation is performed after performing Type 1A, Type 1B, Type 2, and Type 3 table operations. This is because XOR operation for the finish of matrix multiplication is required to be performed by collecting results of matrix multiplication (mixing bijection) performed within Type 1A, Type 1B, Type 2, and Type 3 tables, and such XOR operation is performed in a Type 4 table, and therefore the Type 4 table follows behind other tables.

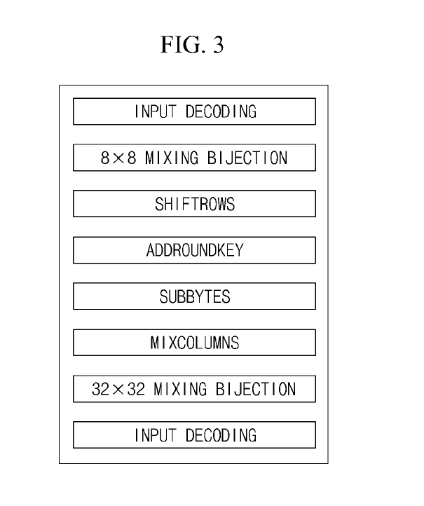

FIG. 3 is a diagram illustrating a structure of a Type 2 table among tables shown in FIG. 2.

Referring to FIG. 3, most of AES round operations are performed in the Type 2 table. In the Type 2 table, there are an 8×8 mixing bijection operation that multiplies an 8×8 invertible matrix before/after the round operation other than decoding of input data and encoding of output data and a 32×32 mixing bijection operation that multiplies a 32×32 invertible matrix. By multiplying these matrixes before/after the round operation, it is possible to safely hide intermediate data of the round operation and a key from a cracker.

In a Type 3 table, by multiplying inverse matrixes of 8×8 matrix (8×8 mixing bijection) and 32×32 matrix (32×32 mixing bijection) which are multiplied in the Type 2 table, only the round operation of AES remains when performing all of Type 2, Type 4, Type 3, and Type 4 table operations. In order to increase the safety of AES, Type 1A and Type 1B tables perform an operation of multiplying a 128×8 invertible matrix to 128-bit input and output data. In addition, the Type 1B table performs a final round operation of AES in addition to a function of protecting the above-described output data not to be directly exposed.

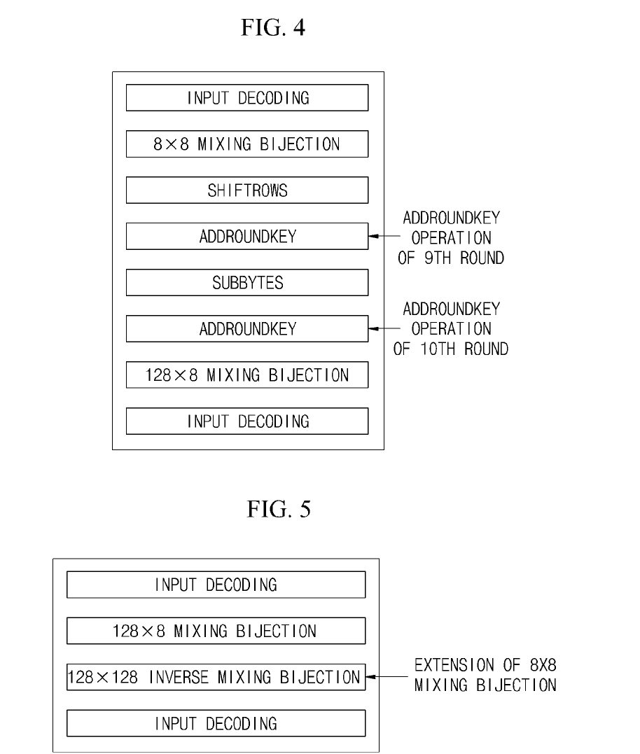

FIG. 4 is a diagram illustrating a structure of a Type 1B table among tables shown in FIG. 2, and FIG. 5 is a diagram illustrating a structure of a Type 1B table among tables shown in FIG. 2.

Referring to FIGS. 4 and 5, an encryption operation of AES performs a round operation 10 times after performing AddRoundKey when performing an encryption operation with respect to 128-bit input data. In AES, initial AddRoundKey is performed within a Type 2 table that performs a first round operation, and AddRoundKey of the first round is performed within a Type 2 table that performs a second round operation, and therefore AddRoundKey for a ninth round and AddRoundKey for a final round are simultaneously performed in the Type 1B table that performs a final round operation.

In addition, an 8×8 mixing bijection operation of the Type 1B table performs operations of multiplying an 8×8 inverse matrix in the Type 3 table in advance among the tables having performed the ninth round operation and multiplying an 8×8 matrix that is an inverse matrix of the 8×8 inverse matrix in the Type 1B table, so that the 8×8 inverse matrix and the 8×8 matrix are offset with each other. As described above, a function of multiplying the 32×32 inverse matrix and the 8×8 inverse matrix is performed in the Type 3 table. Here, the 32×32 inverse matrix is to multiply an inverse matrix of the 32×32 matrix having been multiplied in the Type 2 table of the same round, and the 8×8 inverse matrix is to multiply an inverse matrix of the 8×8 matrix to be multiplied in the Type 2 (Type 1B in a case of the final round) table of the next round. In addition, the inverse matrix of the 8×8 matrix having been multiplied in the Type 2 table in the first round operation is multiplied in the Type 1A table in advance, and therefore the 8×8 matrix and the 8×8 inverse matrix may be offset with each other and disappear.

When operating each table structure that has been described in accordance with the operation sequence shown in FIG. 2, a white box encryption is generated. Even though each table structure is operated in accordance with the operation sequence shown in FIG. 2, the white box algorithm (white box code) may be easily leaked in a security-vulnerable device.

A cracker may directly decrypt intercepted ciphertext through the leaked white box code although the cracker does not know an encryption key. Therefore, in the present invention, disclosed is a method in which implementation of the white box encryption may be dynamically changed in order to prevent the code lifting attack, and the dynamically changed information itself may be managed separately to increase security for the white box encryption.

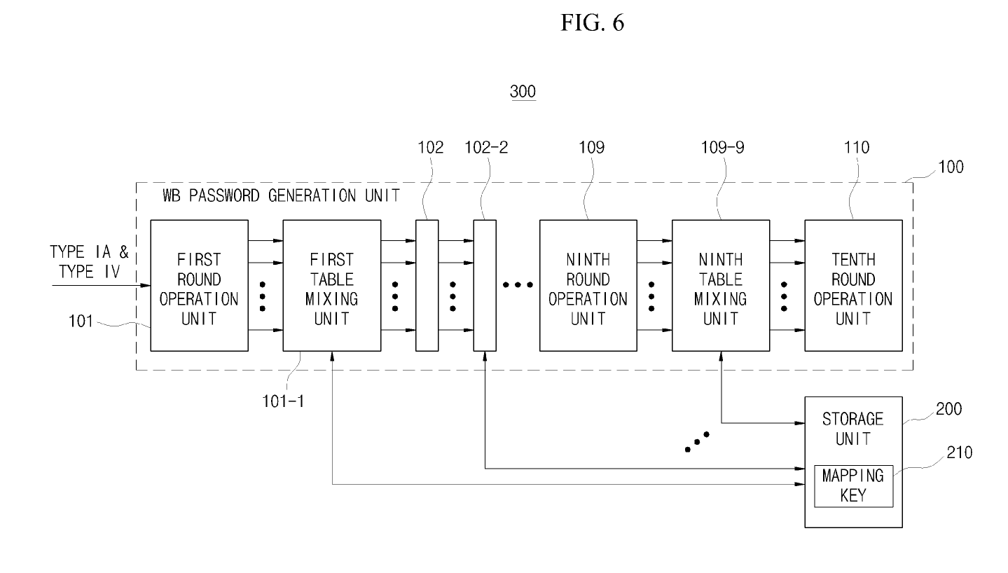

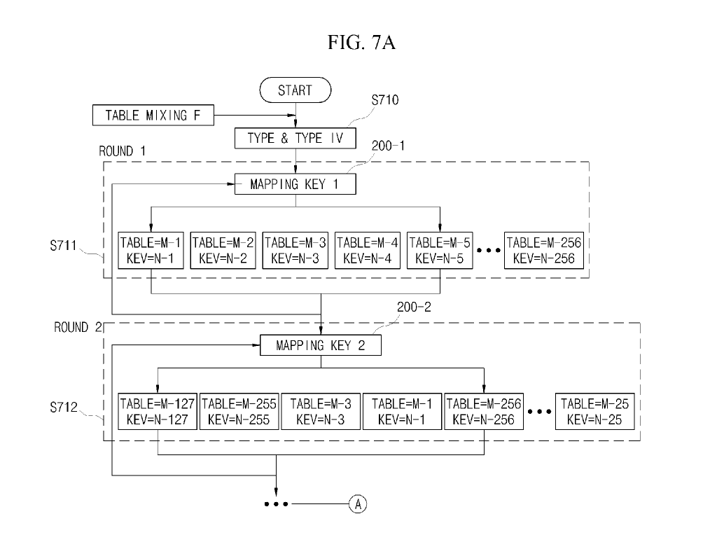

FIG. 6 is a block diagram illustrating a configuration of a white box encryption apparatus according to an exemplary embodiment of the present invention.

Referring to FIG. 6, a white box encryption apparatus 300 according to an embodiment of the present invention includes a white box encryption generation unit 100 and a storage unit 200. The white box encryption generation unit 100 performs a plurality of round operations in order to generate the white box encryption as described in FIGS. 1 to 5. For this, the white box encryption generation unit 100 includes first to tenth round operation units 101 to 110. Each round operation unit performs a round operation including repeatedly performing ShiftRows, AddRoundKey, SubBytes, and MixColumns, and the operation process and operation sequences performed in each round operation unit may be the same as those described in FIGS. 1 to 5. In addition, the white box encryption generation unit 100 includes first to ninth table mixing units 101-1 to 109-9 provided between the round operation units 101 to 110 in order to dynamically change generation of the white box encryption.

Specifically, the first table mixing unit 101-1 receives a plurality of result tables which have been operated in accordance with the first operation sequence (first round) of FIG. 2 from the first round operation unit 101, and performs an operation of randomly mixing the received result tables. For example, when ShiftRows is operated in a unit of 1 byte, the first round operation unit 101 outputs 256 result tables, and the first table mixing unit 101-1 performs an operation of randomly mixing the 256 result tables output from the first round operation unit 101. The randomly mixed 256 result tables are input to the second round operation unit 102, and similarly, the second round operation unit 102 operates the randomly mixed 256 result tables in accordance with the second operation sequence (second round) of FIG. 2 to thereby output the 256 result tables to the second table mixing unit 102-2. The second table mixing unit 102-2 performs the operation of randomly mixing the 256 result tables in the same manner as in the first table mixing unit 101-1, and outputs the 256 result tables to the third round operation unit which is not shown in FIG. 6. According to this procedure, the ninth round operation unit 109 operates result tables of the eighth round operation unit which are randomly mixed by the eighth table mixing unit which is not shown, in accordance with the ninth operation sequence (ninth round) of FIG. 2, and outputs the operated 256 result tables to the ninth table mixing unit 109-9. The ninth table mixing unit 109-9 randomly mixes the 256 result tables operated by the ninth round operation unit 109, and outputs the 256 result tables to the tenth round operation unit 110. The tenth round operation unit 110 performs the corresponding operation in accordance with the operation sequence of FIG. 2 to output ciphertext output data whose encryption has been performed. In this manner, the white box encryption apparatus according to an embodiment of the present invention may dynamically change the generation process of the white box encryption by randomly mixing the result tables corresponding to the operation results for each round.

Meanwhile, in order to decrypt the dynamically changed white box encryption, mapping key information for normally restoring the arrangement of the randomly mixed result tables is provided after each round operation. The mapping key information is stored in the storage unit 200 shown in FIG. 6 and managed separately. Such mapping key information may be separated for each round in order to decrypt the randomly mixed result tables, and the arrangement of the randomly mixed result tables for each round may be normally restored using the mapping key to be separated for each round.

In this manner, when there is no mapping key information that can normally restore the arrangement of the randomly mixed result tables after each round operation, a cracker does not have information related to an arbitrary intermediate operation, that is, the mapping key information even if the white box encryption code itself is leaked, and therefore the corresponding ciphertext cannot be decrypted using the leaked white box encryption code.

Meanwhile, in FIG. 6, an example in which the plurality of round operation units and the plurality of table mixing units are respectively separated is shown, but for aiding the understanding of the description, the plurality of round operation units and the plurality of table mixing units may be functionally separated. Thus, the plurality of round operation units and the plurality of table mixing units may be respectively implemented by a single round operation unit and a single table mixing unit.

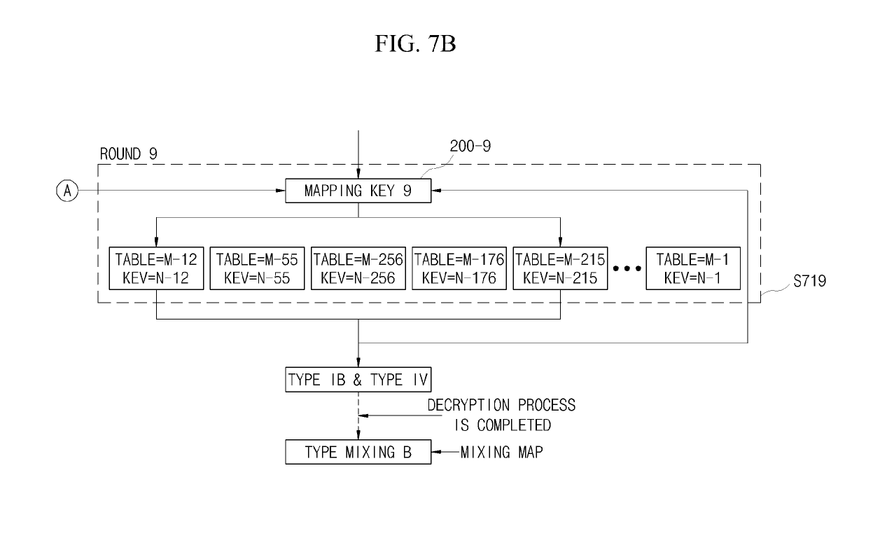

FIGS. 7A and 7B are a diagram illustrating a process of decrypting a dynamically changed white box encryption according to an exemplary embodiment of the present invention. It is assumed that the subject that performs the following each operation is the white box encryption generation unit shown in FIG. 6 unless particularly limited.

Referring to FIG. 7A, in operation S710, a process of receiving a Type 1A table and a Type 4 table is performed in the first round operation unit 101.

In operation S711, a process of restoring the arrangement of 256 tables (Table=m-1 to m-256) which have been randomly mixed in a first round (Round 1) by the first table mixing unit 101-1 is performed. Specifically, the arrangement of the randomly mixed 256 tables is restored in the first round (Round 1) using a first mapping key 200-1 included in the mapping key information shown in FIG. 6. For example, the first mapping key 200-1 may include inverse operation information of the operation of randomly mixing the 256 tables in the first round (Round 1). In a case in which each table is represented as keys (key=n-1 to n-256) numbered from n-1 up to n-256, when each of the numbered tables is randomly mixed in accordance with an arbitrary operation, the numbered keys are also mixed in accordance with the arbitrary operation. Thus, the key arrangement mixed in accordance with the arbitrary operation is restored to an original key arrangement through an inverse operation of the arbitrary operation.

In operation S712, a process of restoring the arrangement of the randomly mixed 256 tables (Table=m-1 to m-256) is performed in a second round (Round 2). This restoration process is performed using the first mapping key 200-1, and is the same as the method performed in operation S711. The process of restoring the arrangement of the tables is performed for each round.

Referring to FIG. 7B, In operation S719, a process of restoring the arrangement of the randomly mixed 256 tables (Table=m-1 to m-256) is performed in the second round (Round 9). This restoration process is performed using the ninth mapping key 200-9, and the process of restoring the arrangement of the tables for each round is completed.

Next, the restored table is operated based on the operation sequence (Type 1B table->Type IV table) according to the tenth round operation, and a series of decryption procedures are completed.

In this manner, a corresponding mapping key 210 is managed separately so that the result tables in units of rounds are mixed and information related to mixing is obtained. Therefore, the mapping key should be obtained so that the normal arrangement of the tables is achieved to perform encryption/decryption, and therefore normal encryption/decryption cannot be performed unless having information related to an arbitrary intermediate operation even though the white box encryption code is leaked, thereby providing more secure white box encryption technology.

Meanwhile, in another embodiment, the process of restoring the arrangement of the tables may be performed for each Type (Type 1A, Type IV, Type II, Type IV, and the like) rather than for each round. When a specific operation method is used in a process of mixing the arrangement of the tables, the mapping key may be simply implemented in a level of involving operation information. Otherwise, when the arrangement of the tables is randomly mixed, the mapping key includes arrangement information.

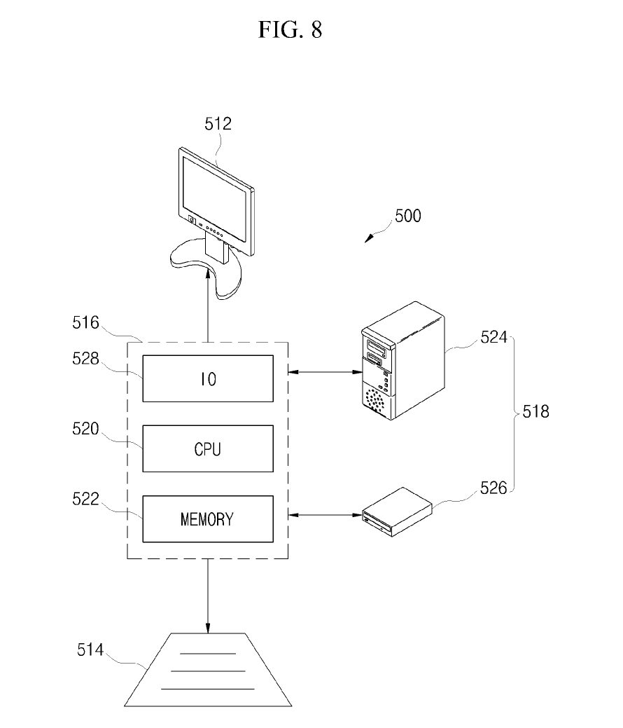

FIG. 8 is a schematic block diagram illustrating a computer system to which a white box encryption apparatus according to an exemplary embodiment of the present invention can be applied.

As shown in FIG. 8, a computer system 500 includes a display 512, a keyboard 514, a computer 516, and an external device 518. The computer 516 includes one or more processors such as a Central Processing Unit (CPU) 520 or microprocessors. The CPU 520 performs mathematical calculation and controls a function of executing software stored in an internal memory 522 and an additional memory 524 such as a random access memory (RAM) and/or read only memory (ROM). The additional memory 524 includes mass memory storage devices, hard disk drives, floppy disk drives, magnetic tape drives, compact disk drives, program cartridges, cartridge interfaces, EPROM or PROM which are found in video game devices, or removable memory chips such as storage media known as a similar technique. In FIG. 8, such an additional memory 524 is physically provided inside or outside the computer 516.

The computer system 500 includes other similar methods of allowing computer programs or other commands to be loaded. In such methods, for example, a communication interface 526 may allow software and data to be transmitted between the computer system 500 and an external system. Examples of the communication interface 526 include a modem, an Ethernet card, and a network interface such as a serial or parallel communication port. The software and data transmitted via the communication interface 526 may be the form of other signals which can be received by electronic, electromagnetic, and optical interfaces, or the communication interface 526. A plurality of interfaces may be provided in a single computer system 500.

Input and output from the computer 516 are operated by an input/output (I/O) interface 528. Such an I/O interface 528 controls the display 512, the keyboard 514, the external device 518, and elements of other computer systems 500.

The present invention is used only for the purpose of convenience under such conditions. It may be more apparent that the present invention can be applied to other computer devices and control systems 500. Thus, the computer devices include a variety of systems including telephones, mobile phones, televisions, television setup units, points of sale computers, automated teller machines (ATM), laptop computers, servers, personal electronic assistants, a variety of appliances of cars, and the like. As shown in FIG. 8, such a computer device may include additional components or delete any component.

In the above, for the purpose of explanation, a variety of details have been disclosed in order to provide thorough understanding of the embodiments of the present invention. However, those skilled in the art will appreciate that such details are not required in performing the present invention. In other cases, well-known electrical structures and circuits are shown in the form of block diagram so as to prevent the present invention from being obscure. For example, details concerning whether the embodiments of the present invention are implemented in a software routine, a hardware circuit, a firmware, or a combination thereof are not provided.

Embodiments of the invention may be represented as a software product stored in a machine-readable medium (also referred to as a computer-readable medium, a processor-readable medium, or a computer-usable medium having a computer-readable program embodied therein). The machine-readable medium may be any suitable tangible medium including a magnetic, optical, or electrical storage medium including a diskette, a compact disk read only memory (CD-ROM), a memory device (volatile or non-volatile), or a similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

As described above, according to the present invention, inverse operation information of operation information operated between each round should be obtained even if a code (or a table) or the like implemented by the white box encryption algorithm is leaked, so that normal encryption and decryption may be performed, thereby providing more secure white box encryption technology.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A white box encryption apparatus comprising:
an operation unit that performs an encryption operation using a plurality of white box encryption tables for each of a plurality of rounds; and
a table mixing unit that mixes arrangement of result tables output for each round.

2. The white box encryption apparatus of claim 1, wherein the mixed arrangement of the result tables is decrypted in a normal arrangement order by mapping key information set in advance.

3. The white box encryption apparatus of claim 2, wherein the mapping key information includes a plurality of mapping keys separated for each round.

4. The white box encryption apparatus of claim 2, wherein the table mixing unit randomly mixes the arrangement of the result tables output for each round in accordance with a specific operation, and
the mapping key information includes information about an inverse operation of the specific operation.

5. The white box encryption apparatus of claim 2, wherein the table mixing unit randomly mixes the arrangement of the result tables output for each round, and
the mapping key information includes information about an arrangement order of the randomly mixed arrangement of the result tables.

6. The white box encryption apparatus of claim 2, wherein the mapping key information is stored and managed in an external memory.

7. A white box encryption method comprising:
performing an encryption operation using a plurality of white box encryption tables for each of a plurality of rounds; and
mixing arrangement of result tables output for each round.

8. The white box encryption method of claim 7, wherein the mixed arrangement of the result tables is decrypted in a normal arrangement order by mapping key information set in advance.

9. The white box encryption method of claim 8, wherein the mapping key information includes a plurality of mapping keys separated for each round.

10. The white box encryption method of claim 8, wherein the mixing includes randomly mixing the arrangement of the result tables output for each round in accordance with a specific operation, and
the mapping key information includes information about an inverse operation of the specific operation.

11. The white box encryption method of claim 8, wherein the mixing includes randomly mixing the arrangement of the result tables output for each round, and
the mapping key information includes information about an arrangement order of the randomly mixed arrangement of the result tables.

12. The white box encryption method of claim 8, wherein the mapping key information is stored and managed in an external memory.
